(19) United States
(12) Patent Application Publication
(10) Pub. No.: US 2012/0066487 A1
(43) Pub. Date: Mar. 15, 2012

(54) SYSTEM AND METHOD FOR PROVIDING LOAD BALANCER VISIBILITY IN AN INTELLIGENT WORKLOAD MANAGEMENT SYSTEM

(75) Inventors: Jeremy Brown, Orem, UT (US); Jason Allen Sabin, Lehi, UT (US); Nathaniel Brent Kranendonk, Springvillle, UT (US); Kal A. Larsen, Springville, UT (US); Lloyd Leon Burch, Payson, UT (US)

(73) Assignee: Novell, Inc., Provo, UT (US)

(21) Appl. No.: 12/878,180

(22) Filed: Sep. 9, 2010

(51) Int. Cl. G06F 15/173; H04L 9/00

(52) U.S. Cl. 713/150; 709/224

(57) ABSTRACT

The system and method for providing load balancer visibility in an intelligent workload management system described herein may expand a role or function associated with a load balancer beyond handling incoming and outgoing data center traffic into supporting governance, risk, and compliance concerns that may be managed in an intelligent workload management system. In particular, the load balancer may establish external connections with destination resources in response to client devices establishing internal connections with the load balancer and then attach connection tracers to monitor the internal connections and the external connections. The connection tracers may then detect incoming traffic and outgoing traffic that the internal and external connections pass through the load balancer, and traffic tracers may collect data from the incoming traffic and the outgoing traffic, which the workload management system may use to manage the data center.

### FIELD OF THE INVENTION

The invention generally relates to a system and method for providing load balancer visibility in an intelligent workload management system, and in particular, to expanding a role or function associated with a load balancer beyond handling incoming and outgoing data center traffic into supporting governance, risk, and compliance concerns that may be managed in an intelligent workload management system.

### BACKGROUND OF THE INVENTION

Many current efforts ongoing within the information technology community include considerable interest in the concept of “intelligent workload management.” In particular, much of the recent development in the information technology community has focused on providing better techniques to intelligently mange “cloud” computing environments, which generally include dynamically scalable virtualized resources that typically provide network services. For example, cloud computing environments often use virtualization as the preferred paradigm to host workloads on underlying physical hardware resources. For various reasons, computing models built around cloud or virtualized data centers have become increasingly viable, including cloud infrastructures can permit information technology resources to be treated as utilities that can be automatically provisioned on demand. Moreover, cloud infrastructures can limit the computational and financial cost that any particular service has to the actual resources that the service consumes, while further providing users or other resource consumers with the ability to leverage technologies that could otherwise be unavailable. Thus, as cloud computing and storage environments become more pervasive, many information technology organizations will likely find that moving resources currently hosted in physical data centers to cloud and virtualized data centers can yield economies of scale, among other advantages.

Nonetheless, although many efforts in the information technology community relates to moving towards cloud and virtualized computing environments, existing systems tend to fall short in providing adequate solutions that can manage or control such environments. For example, cloud computing environments are generally designed to support generic business practices, meaning that individuals and organizations typically lack the ability to change many aspects of the platform. Moreover, concerns regarding performance, latency, reliability, and security can present significant challenges because outages and downtime often lead to lost business opportunities and decreased productivity, while the generic platform may present governance, risk, and compliance concerns. In other words, once organizations deploy workloads beyond data center boundaries, the lack of visibility into the computing environment that hosts the workloads may result in significant management problems. In this context, the most difficult problem with managing a data center relates to troubleshooting, especially with load balancers that typically segment internal and external traffic. In particular, client devices lack visibility into virtualized and cloud data centers that may be needed to identify particular machines delivering content to the client devices. Similarly, servers lack the visibility needed to identify the content being delivered to client devices without implementing custom logging techniques for every application that may be delivering the content to the client devices.

Moreover, existing systems that attempt to manage cloud and virtualized computing environments often exacerbate the foregoing problems with load balancer visibility because suitably managing highly dynamic cloud and virtualized computing environments requires visibility inside and outside the data centers. In particular, load balancers usually present substantial management obstacles because systems that attempt to troubleshoot and gather management data must work around the load balancers. For example, customers commonly request that information technology service providers supply additional tools to troubleshoot applications, but adding more troubleshooting tools to an application often only cause the application to slow down. Accordingly, although existing systems have attempted to provide solutions that can troubleshoot and gather management data around load balancers, the solutions that have been proposed tend to fall short in providing techniques that can suitably troubleshoot, audit, and log management data without impacting performance.

### SUMMARY OF THE INVENTION

According to one aspect of the invention, the system and method described herein may provide load balancer visibility in an intelligent workload management system. In particular, the system and method described herein may generally operate in a computing environment having a fluid architecture, whereby the computing environment may create common threads that converge information relating to user identities and access credentials, provisioned and requested services, and physical and virtual infrastructure resources, among other things. As such, the system and method described herein may use the information converged in the common threads to provide visibility into various load balancers that may be used to manage workloads in the intelligent workload management system. For example, the intelligent workload management system may provide various services that aggregate physical and/or virtualized resources, while applications provided in the intelligent workload management system may aggregate various services and workloads that compose whole services, separate services, and sub-services that can work together. For example, the intelligent workload management system (or alternatively “the workload management system”) may create workloads to provision tuned appliances that may be configured to perform particular functions or host particular applications, whereby the tuned appliances may provide services to one or more users. To manage the workloads, the workload management system may create resource stores that point to storage locations for the appliances, declare service level agreements and any runtime requirements that constrain deployment for the appliances, obtain certificates that provide attestation tokens for the users and the appliances, and create profiles that provide audit trails describing actual lifecycle behavior for the appliances (e.g., events and performance metrics relating to the appliances).

According to one aspect of the invention, the system and method described herein may operate in a model-driven architecture, which may merge information relating to user identities with services that may be running in an information technology infrastructure. As such, the information merged in the model-driven architecture may be referenced to determine specific users or organizational areas within the infrastructure that may be impacted in response to a particular change to the infrastructure model. Thus, the model-driven architecture may track contexts associated with information technology workloads from start to finish, which may provide the audit trails that can then be referenced to identify relevant users, applications, systems, or other entities that can assist with particular issues. Moreover, to manage workloads that provide virtualized services, where different users typically need the ability to communicate with one another on-demand, the audit trails created in the model-driven architecture may track end-to-end workload activities and thereby provide visibility and notice to users, applications, systems, services, or any other suitable entities that the workloads may impact. Furthermore, the workload management system may operate in a service-oriented architecture that can unify various heterogeneous technologies, whereby the workload management system may enable the agility and flexibility needed to have an information technology infrastructure move at the speed of modern business. In particular, the service-oriented architecture may provide adaptable and interoperable information technology tools that can address many business challenges that information technology organizations typically face. For example, the model-driven architecture may provide various virtualization services to create manageable workloads that can be moved efficiently throughout the infrastructure, while the service-oriented architecture may merge different technologies to provide various coordinated and cooperating systems that can optimally execute distributed portions of an overall orchestrated workload. As such, the model-driven and service-oriented architectures may collectively derive data from the information technology infrastructure, which may inform intelligent information technology choices that meet the needs of businesses and users.

According to one aspect of the invention, the system and method described herein may expand a role or function associated with a load balancer beyond handling incoming and outgoing data center traffic into supporting governance, risk, and compliance concerns that may be managed with the workload management system. In particular, the load balancer may generally balance loads associated with routing and delivering incoming and outgoing traffic in the data center and include functionality that can collect management data from the incoming and outgoing traffic while balancing the loads associated therewith (e.g., user identities, credentials, applications, physical and virtualized information technology resources, etc.). As such, the functionality that the load balancer includes to collect the management data may provide a governance, risk, and compliance solution that can be used to manage workloads associated with any suitable client device or application that uses the load balancer. Moreover, because the load balancer collects management data from the incoming and outgoing traffic while balancing the loads associated therewith, the system and method described herein may provide tools that can be used to troubleshoot, audit, and otherwise manage the data center without impacting performance.

According to one aspect of the invention, the system and method described herein may have the load balancer receive a request originating from a client device, wherein the load balancer may then assign the client device a virtual network address used to route incoming and outgoing traffic associated with the client device. As such, any incoming traffic directed to the load balancer in response to the request may be directed to the virtual network address assigned to the client device, whereby the load balancer may redirect such incoming traffic to a physical network interface associated with the client device. Accordingly, assigning the virtual network address to the client device may provide connection redundancy in the load balancer (e.g., in scenarios where the incoming traffic cannot be redirected to the physical network interface associated with the client device). In one implementation, the load balancer may therefore further include a traffic delivery module that passes the incoming and outgoing traffic through the load balancer, while an indexing service may include configurations that define relationships that the traffic delivery module uses to route or deliver traffic originating from or directed to certain virtual network addresses. In one implementation, the load balancer may read the configuration from the indexing service and pass the configuration to a traffic tracer.

According to one aspect of the invention, the system and method described herein may pass the configuration to the traffic tracer, which may reference the configuration to attach connection tracers into any internal or external connections with the load balancer. In one implementation, the connection tracers may attach suitable identifiers to the internal or external connections with the load balancer, wherein the identifiers may depend on a particular communication protocol used in the internal and external connections (e.g., different identifiers may be attached to connections that include messages communicated with Transmission Control Protocol, Secure Socket Layer, etc.). Furthermore, in response to the load balancer receiving any incoming traffic directed to the client device, the traffic tracer may similarly attach connection tracers into any connections that return the traffic to the load balancer to trace incoming connections directed back to the client device. In one implementation, the traffic tracer may then collect data describing any traffic that the internal and external connections pass through the load balancer. In particular, the connection tracers may notify the traffic tracer in response to detecting traffic passing through the load balancer, whereby the traffic tracer may collect data describing the traffic passing traffic through the load balancer in response to receiving the notification from the connection tracers. Furthermore, in one implementation, the traffic tracer may apply various heuristics, filters, and other rules to the collected data, wherein the configuration may define identity controls, policies, service level agreements, or other criteria that define relevant data to collect from the traffic.

According to one aspect of the invention, the system and method described herein may further include a decoder in the load balancer to decode messages within the incoming and traffic that include encoded data. In particular, certain communication protocols may be used to encrypt segments within the connections that pass traffic through the load balancer. As such, in response to the traffic tracer determining that the collected data includes one or more encrypted messages, the decoder may decode the messages and apply further rules to the decoded message in order to collect relevant management data. Furthermore, in one implementation, the traffic tracer may initially apply the heuristics, filters, and other rules to determine whether or not to decode the encrypted messages.

According to one aspect of the invention, the system and method described herein may provide data resulting from the traffic tracer applying the heuristics, filters, and other rules to a data ordering module associated with the indexing service, which may order the resulting data according to time, content, or other suitable criteria. In one implementation, the data ordering module may employ any suitable technique to order the data collected with the traffic tracer and provided to the indexing service, and may store the ordered data in one or more databases or other suitable repositories. Furthermore, in one implementation, depending on the size and complexity of the ordered data, the indexing service may be distributed or otherwise separated into multiple components. In one implementation, the ordered data may then be analyzed with a report generator that obtains relevant governance, risk, and compliance data associated with the incoming and outgoing traffic that passed through the load balancer. In particular, the report generator may be configured with various requirements that define the relevant governance, risk, and compliance issues that may apply to the incoming and outgoing traffic that passed through the load balancer, whereby the report generator may analyze the data ordered with the data ordering module in view of the requirements to report on the incoming and outgoing traffic that passed through the load balancer. Thus, using the system and method described in further detail herein, the workload management system may obtain any suitable management data that can be used to manage incoming and outgoing traffic that passes through the load balancer.

Other objects and advantages of the invention will be apparent to those skilled in the art based on the following drawings and detailed description.

### BRIEF DESCRIPTION OF THE DRAWINGS

FIG. 1A illustrates a block diagram of an exemplary model-driven architecture in an intelligent workload management system, while FIG. 1B illustrates a block diagram of an exemplary service-oriented architecture in the intelligent workload management system, according to one aspect of the invention.

FIG. 2 illustrates an exemplary system that provides load balancer visibility in the intelligent workload management system shown in FIG. 1A and FIG. 1B, according to one aspect of the invention.

FIG. 3 illustrates an exemplary method that provides load balancer visibility in the intelligent workload management system shown in FIG. 1A and FIG. 1B, according to one aspect of the invention.

### DETAILED DESCRIPTION

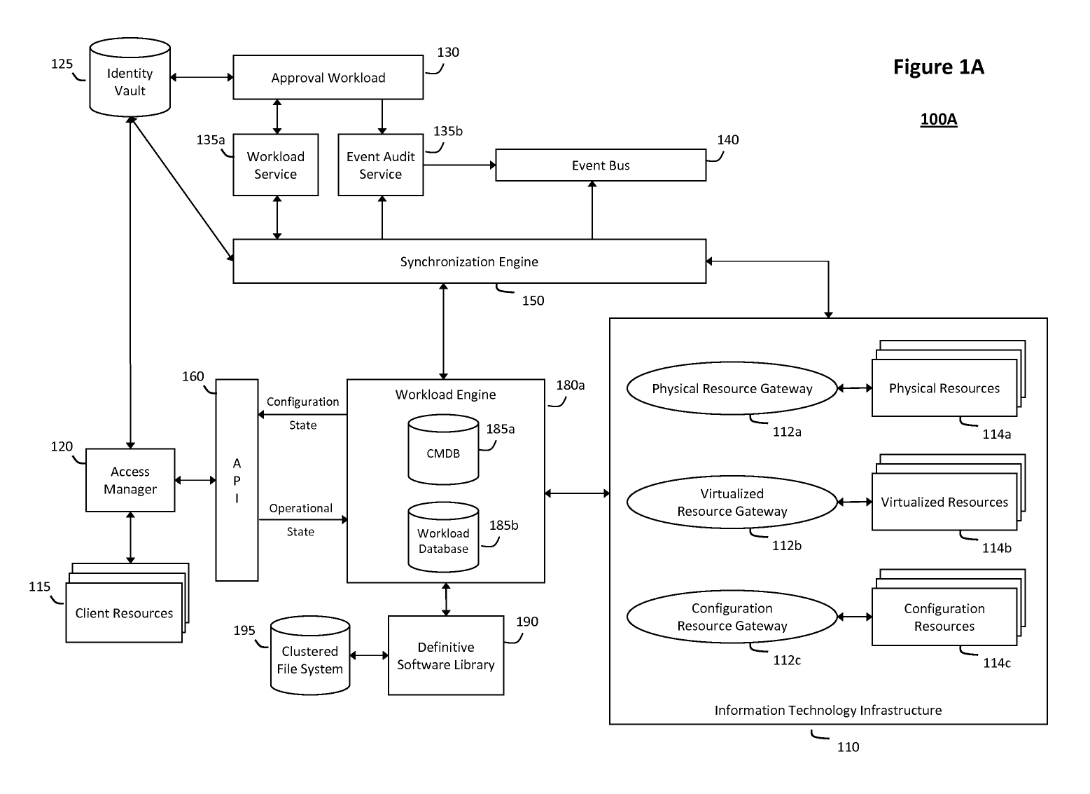

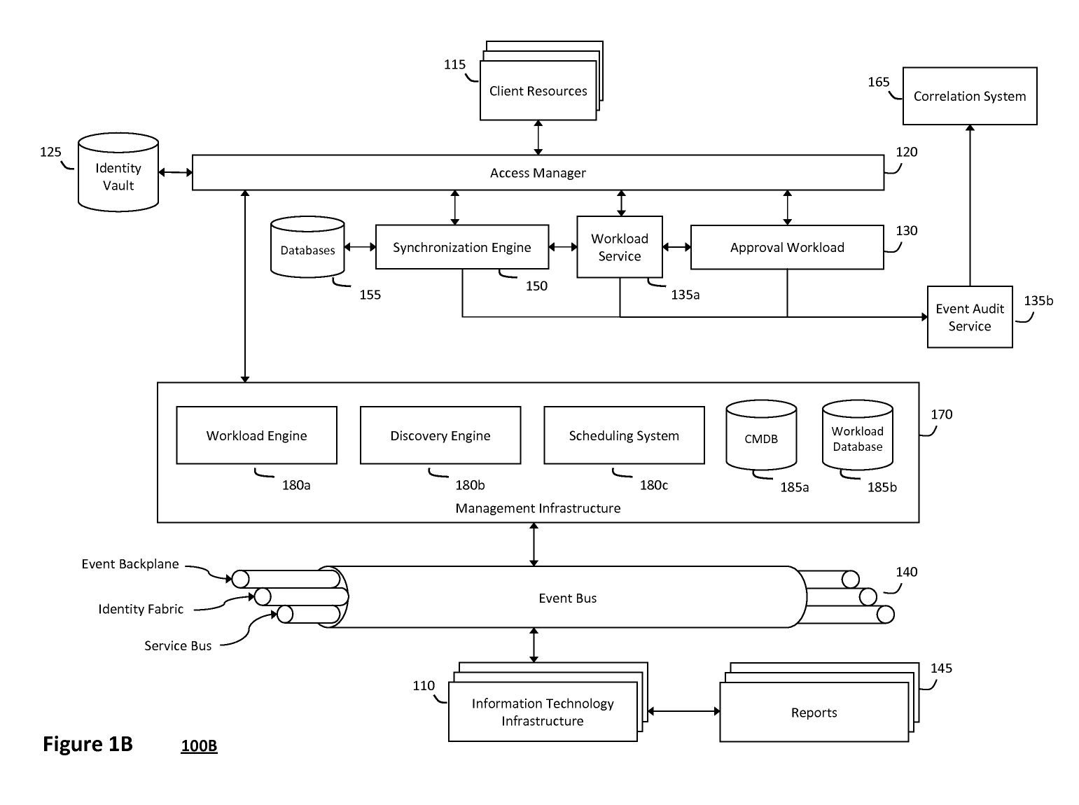

According to one aspect of the invention, FIG. 1A illustrates an exemplary model-driven architecture 100A in an intelligent workload management system, while FIG. 1B illustrates an exemplary service-oriented architecture 100B in the intelligent workload management system. In one implementation, the model-driven architecture 100A shown in FIG. 1A and the service-oriented architecture 100B shown in FIG. 1B may include various components that operate in a substantially similar manner to provide the functionality that will be described in further detail herein. Thus, any description provided herein for components having identical reference numerals in FIGS. 1A and 1B will be understood as corresponding to such components in both FIGS. 1A and 1B, whether or not explicitly described.

In one implementation, the model-driven architecture 100A illustrated in FIG. 1A and the service-oriented architecture 100B illustrated in FIG. 1B may provide an agile, responsive, reliable, and interoperable information technology environment, which may address various problems associated with managing an information technology infrastructure 110 (e.g., growing revenues and cutting costs, managing governance, risk, and compliance, reducing times to innovate and deliver products to markets, enforcing security and access controls, managing heterogeneous technologies and information flows, etc.). To that end, the model-driven architecture 100A and the service-oriented architecture 100B may provide a coordinated design in the intelligent workload management system (or alternatively “the workload management system”), wherein the coordinated design may integrate technologies for managing identities, enforcing policies, assuring compliance, managing computing and storage environments, providing orchestrated virtualization, enabling collaboration, and providing architectural agility, among other things. The model-driven architecture 100A and the service-oriented architecture 100B may therefore provide a flexible framework that may enable the workload management system to allocate various resources 114 in the information technology infrastructure 110 in a manner that balances governance, risk, and compliance with capacities for internal and external resources 114. For example, as will be described in further detail herein, the workload management system may operate within the flexible framework that the model-driven architecture 100A and the service-oriented architecture 100B to deliver information technology tools for managing security, performance, availability, and policy objectives for services provisioned in the information technology infrastructure 110.

Identity Management

In one implementation, as noted above, the technologies integrated by the model-driven architecture 100A and the service-oriented architecture 100B may enable managing identities in the information technology infrastructure 110. In particular, managing identities may present an important concern in the context of managing services in the information technology infrastructure 110 because security, performance, availability, policy objectives, and other variables may have different importance for different users, customers, applications, systems, or other resources 114 that operate in the information technology infrastructure 110. As such, the model-driven architecture 100A and the service-oriented architecture 100B may include various components that enable identity management in the information technology infrastructure 110.

For example, in one implementation, the workload management system may include an access manager 120 (e.g., Novell Access Manager), which may communicate with an identity vault 125 and control access to content, applications, services, and other resources 114 in the information technology infrastructure 110. In one implementation, the access manager 120 may enforce various policy declarations to provide authentication services for any suitable component in the information technology infrastructure 110. For example, the identity vault 125 may include various directories that organize user accounts, roles, policies, and other identity information that the access manager 120 can reference to generate authorization decisions. The access manager 120 and the identity vault 125 may further support federated user identities, wherein a user at any particular client resource 115 may submit single sign-on authentication credentials to the access manager 120, which may then control access to any suitable resource 114 in the information technology infrastructure 110 with the single sign-on authentication credentials (e.g., user names, identifiers, passwords, smart cards, biometrics, etc.). Moreover, the identity information stored in the identity vault 125 may be provided to a synchronization engine 150, whereby the synchronization engine 150 may provide interoperable and transportable identity information throughout the architecture (e.g., via an identity fabric within an event bus 140 that manages transport throughout the architecture).

In one implementation, providing the identity information stored in the identity vault 125 to the synchronization engine 150 may form portable identities that correspond to independent digital representations for various users, applications, systems, or other entities that interact with the information technology infrastructure 110. In particular, the identities maintained in the synchronization engine 150 may generally include abstractions that can provide access to authoritative attributes, active roles, and valid policies for entities that the identity abstractions represent. Thus, synchronizing the identity information stored in the identity vault 125 with the synchronization engine 150 may provide independent and scalable digital identities that can be transported across heterogeneous applications, services, networks, or other systems, whereby the workload management system may handle and validate the digital identities in a cooperative, interoperable, and federated manner.

In one implementation, the identities stored in the identity vault 125 and synchronized with the synchronization engine 150 may be customized to define particular attributes and roles that the identities may expose. For example, a user may choose to create one identity that exposes every attribute and role for the user to applications, services, or other systems that reside within organizational boundaries, another identity that limits the attributes and roles exposed to certain service providers outside the organizational boundaries, and another identity that provides complete anonymity in certain contexts. The identities maintained in the synchronization engine 150 may therefore provide awareness over any authentication criteria that may be required to enable communication and collaboration between entities that interact with the workload management system. For example, the synchronization engine 150 may include a service that can enforce policies controlling whether certain information stored in the identity vault 125 can be shared (e.g., through the access manager 120 or other information technology tools that can manage and customize identities).

In one implementation, the workload management system may further manage identities in a manner that enables infrastructure workloads to function across organizational boundaries, wherein identities for various users, applications, services, and other resources 114 involved in infrastructure workloads may be managed with role aggregation policies and logic that can support federated authentication, authorization, and attribute services. For example, in one implementation, the access manager 120, the identity vault 125, and the synchronization engine 150 may manage identity services externally to applications, services, and other resources 114 that consume the identities, which may enable the workload management system to control access to services for multiple applications using consistent identity interfaces. In particular, the access manager 120, the identity vault 125, and the synchronization engine 150 may define standard interfaces for managing the identity services, which may include authentication services, push authorization services (e.g., tokens, claims, assertions, etc.), pull authorization services (e.g., requests, queries, etc.), push attribute services (e.g., updates), pull attribute services (e.g., queries), and audit services.

As such, in one implementation, the workload management system may employ the identity services provided in the model-driven architecture 100A and the service-oriented architecture 100B to apply policies for representing and controlling roles for multiple identities within any particular session that occurs in the information technology infrastructure 110. For example, in response to a session that includes a user logging into a client machine 115 and invoking a backup service, the workload management system may manage the session with multiple identities that encompass the user, the backup service, and the client machine 115. The workload management system may further determine that the identity for the client machine 115 represents an unsecured machine that resides outside an organizational firewall, which may result in the workload management system retrieving a policy from the identity vault 125 and/or the synchronization engine 150 and applying the policy to the session (e.g., the policy may dynamically prevent the machine 115 and the user from being active in the same session). Thus, the workload management system may manage multiple identities that may be involved in any particular service request to control and secure access to applications, services, and other resources 114 in the information technology infrastructure 110.

In one implementation, the model-driven architecture 100A and the service-oriented architecture 100B may further provide identity services for delegating rights in delegation chains that may involve various different levels of identities. In particular, any particular user may have various roles, attributes, or other identities that define various rights for the user. As such, in one implementation, the rights delegation identity service may enable the user to delegate a time-bounded subset of such rights to a particular service, wherein the service can then make requests to other services on behalf of the user during the delegated time. For example, a user may delegate rights to a backup service that permits the backup service to read a portion of a clustered file system 195 during a particular time interval (e.g., 2 a.m. to 3 a.m.). In response to the file system 195 receiving the read request from the backup service, the identity services may enable the file system 195 to audit identities for the backup service and the user, and further to constrain read permissions within the file system 195 based on the relevant rights defined by the identities for the backup service for the user.

In one implementation, the model-driven architecture 100A and the service-oriented architecture 100B may further provide identity services for defining relative roles, wherein relative roles may be defined where a principal user, application, service, or other entity can only assume a particular role for a particular action when a target of the action has a particular set of identities. For example, a user having a doctor role may only assume a doctor-of-record relative role if an identity for a target of the doctor-of-record action refers to one of the user's patients. In another example, applications may request controlled access to information about an identity for a certain user, wherein the application may retrieve the requested information directly from the access-controlled identity for the user. In particular, the workload management system may determine the information requested by the application and create a workload that indicates to the user the information requested by the application and any action that the application may initiate with the requested information. The user may then make an informed choice about whether to grant the application access to the requested information. Thus, having identities to enable applications may eliminate a need for application-specific data storage or having the application access separate a directory service or another identity information source.

Thus, in the model-driven architecture 100A and the service-oriented architecture 1006, the identity management services may create crafted identities combined from various different types of identity information for various users, applications, services, systems, or other information technology resources 114. In one implementation, while the identity information may generally be stored and maintained in the identity vault 125, the identity information can be composed and transformed through the access manager 120 and/or the synchronization engine 150, with the resulting identity information providing authoritative statements for represented entities that span multiple authentication domains within and/or beyond boundaries for the information technology infrastructure 110. For example, an identity for a user may be encapsulated within a token that masks any underlying credential authentication, identity federation, and attribute attestation. Moreover, in one implementation, the identity services may further support identities that outlive entities that the identities represent and multiple identity subsets within a particular identity domain or across multiple identity domains. As such, the identity services provided in the model-driven architecture 100A and the service-oriented architecture 100B may include various forms of authentication, identifier mapping, token transformation, identity attribute management, and identity relationship mapping.

Policy Enforcement

In one implementation, as noted above, the technologies integrated by the model-driven architecture 100A and the service-oriented architecture 100B may enable enforcing policies in the information technology infrastructure 110. In particular, enforcing policies may present an important concern in the context of managing services in the information technology infrastructure 110 because policies may be driven from multiple hierarchies and depend on operational, legislative, and organizational requirements that can overlap, contradict, and/or override each other. As such, the model-driven architecture 100A and the service-oriented architecture 100B may include various components for defining policies in standardized languages that can be translated, merged, split, or otherwise unified as needed. To that end, the workload management system may have multiple policy decision points and policy definition services for consistently managing and enforcing policies in the information technology infrastructure 110

As such, in one implementation, the model-driven architecture 100A and the service-oriented architecture 100B may provide standard policy languages and service interfaces that enable the workload management system to make consistent decisions based on flexible user needs. In particular, any suitable resource 114 (including workloads and computational infrastructure) may be provided with access to standardized instrumentation that provides knowledge regarding information that may be available, desired, or allowed in the workload management system. In one implementation, the workload management system may invoke various cooperating policy services to determine suitable physical resources 114a (e.g., physical servers, hardware devices, etc.), virtualized resources 114b (e.g., virtual machine images, virtualized servers, etc.), configuration resources 114c (e.g., management agents, translation services, etc.), storage resources (e.g., the clustered file system 195, one or more databases 155, etc.), or other resources 114 for a particular workload. For example, the synchronization engine 150 may dynamically retrieve various policies stored in the databases 155, and an event audit service 135b may then evaluate the policies maintained in the synchronization engine 150 independently from services that subsequently enforce policy decisions (e.g., the event audit service 135b may determine whether the policies permit access to certain information for a particular application and the application may then enforce the policy determination).

In one implementation, separating policy evaluation within the event audit service 135b from policy enforcement within consuming services may enable the workload management system to access the consuming services and manage policy-based control for the service in an independent and simultaneous manner. The event audit service 135b may include a standardized policy definition service that can be used to define policies that span multiple separate application and management domains. For example, in one implementation, the policy definition service may create, manage, translate, and/or process policies separately from other service administration domains and interfaces. As such, the policy definition service may provide interoperability for the separate domains and interfaces, and may further enable compliance services that may be provided in a correlation system 165 and remediation services that may be provided in a workload service 135a.

In one implementation, to ensure correct and effective policy decisions, the policy definition service provided within the event audit service 135b may be configured to obtain data relating to a current state and configuration for resources 114 managed in the infrastructure 110 in addition to data relating to dependencies or other interactions between the managed resources 114. For example, a management infrastructure 170 may include a discovery engine 180b that dynamically monitors various events that the infrastructure 110 generates and pushes onto the event bus 140, which may include an event backplane for transporting the events. Moreover, the discovery engine 180b may query the infrastructure 110 to determine relationships and dependencies among users, applications, services, and other resources 114 in the infrastructure 110. As such, the discovery engine 180b may monitor the event bus 140 to obtain the events generated in the infrastructure 110 and synchronize the events to the synchronization engine 150, and may further synchronize information relating to the relationships and dependencies identified in the infrastructure 110 to the synchronization engine 150. In one implementation, the event audit service 135b may then evaluate any events, resource relationships, resource dependencies, or other information describing the operational state and the configuration state of the infrastructure 110 in view of any relevant policies and subsequently provide any such policy evaluations to requesting entities.

In one implementation, the policy definition service may include standard interfaces for defining policies in terms of requirements, controls, and rules. For example, the requirements may generally be expressed in natural language in order to describe permitted functionality, prohibited functionality, desirable functionality, and undesirable functionality, among other things (e.g., the event audit service 135b may capture legislative regulations, business objectives, best practices, or other policy-based requirements expressed in natural language). The controls may generally associate the requirements to particular objects that may be managed in the workload management system, such as individual users, groups of users, physical resources 114a, virtualized resources 114b, or any other suitable object or resource 114 in the infrastructure 110. In one implementation, the policy definition service may further define types for the controls. For example, the type may include an authorization type that associates an identity with a particular resource 114 and action (e.g., for certain identities, authorizing or denying access to a system or a file, permission to alter or deploy a policy, etc.), or the type may include an obligation type that mandates a particular action for an identity.

Thus, in one implementation, translating requirements into controls may partition the requirements into multiple controls that may define policies for a particular group of objects. Furthermore, rules may apply certain controls to particular resources 114, wherein rules may represent concrete policy definitions. For example, the rules may be translated directly into a machine-readable and machine-executable format that information technology staff may handle and that the event audit service 135b may evaluate in order to manage policies. In one implementation, the rules may be captured and expressed in any suitable domain specific language, wherein the domain specific language may provide a consistent addressing scheme and data model to instrument policies across multiple domains. For example, a definitive software library 190 may include one or more standardized policy libraries for translating between potentially disparate policy implementations, which may enable the event audit service 135b to provide federated policies interoperable across multiple different domains. As such, the rules that represent the policy definitions may include identifiers for an originating policy implementation, which the policy definition service may then map to the controls that the rules enforce and to the domain specific policy language used in the workload management system (e.g., through the definitive software library 190).

Compliance Assurance

In one implementation, as noted above, the technologies integrated by the model-driven architecture 100A and the service-oriented architecture 100B may enable monitoring for compliance assurances in the information technology infrastructure 110. In particular, compliance assurance may present an important concern in the context of managing services in the information technology infrastructure 110 because policy enforcement encompasses issues beyond location, access rights, or other contextual information within the infrastructure (e.g., due to increasing mobility in computing environments). As such, the model-driven architecture 100A and the service-oriented architecture 100B may define metadata that bounds data to characteristics of data. To that end, the workload management system may employ a standard metadata format to provide interoperability between policies from multiple organizations to enable the policies to cooperate with one another and provide policy-based service control. For example, certain infrastructure workloads may execute under multiple constraints defined by users, the infrastructure 110, sponsoring organizations, or other entities, wherein compliance assurance may provide users with certification that the workloads were properly assigned and executed according to the constraints. In another example, sponsoring organizations and governing bodies may define control policies that constrain workloads, wherein compliance assurance in this context may include ensuring that only authorized workloads have been executed against approved resources 114.

As such, in one implementation, the model-driven architecture 100A and the service-oriented architecture 100B may provide preventative compliance assurance through a compliance management service that supports remediation in addition to monitoring and reporting. For example, when workloads move from data centers internal to the infrastructure 110 into third party processing centers, cloud computing environments, or other environments having reusable computing resource pools where services can be relocated, the workload management system may generate compliance reports 145 that indicate whether any constraints defined for the workloads have been satisfied (e.g., that authorized entities perform the correct work in the correct manner, as defined within the workloads). Thus, compliance may generally be defined to include measuring and reporting on whether certain policies effectively ensure confidentiality and availability for information within workloads, wherein the resulting compliance reports 145 may describe an entire process flow that encompasses policy definition, relationships between configurations and activities that do or do not comply with the defined policies, and identities of users, applications, services, systems, or other resources 114 involved in the process flow.

In one implementation, the workload management system may provide the compliance management service for workloads having specifications defined by users, and further for workloads having specifications defined by organizations. For example, users may generally define various specifications to identify operational constraints and desired outcomes for workloads that the users create, wherein the compliance management service may certify to the users whether or not the operational constraints and desired outcomes have been correctly implemented. With respect to organizational workloads, organizations may define various specifications identifying operational constraints and desired outcomes for ensuring that workloads comply with governmental regulations, corporate best practices, contracts, laws, and internal codes of conduct. Thus, the compliance management service may integrate the identity management services and the policy definition service described above to provide the workload management system with control over configurations, compliance event coverage, and remediation services in the information technology infrastructure 110.

In one implementation, the compliance management service may operate within a workload engine 180a provided within the management infrastructure 170 and/or a workload service 135b in communication with the synchronization engine 150. The workload engine 180a and/or the workload service 135b may therefore execute the compliance management service to measure and report on whether workloads comply with relevant policies, and further to remediate any non-compliant workloads. For example, the compliance management service may use the integrated identity management services to measure and report on users, applications, services, systems, or other resources 114 that may be performing operational activity that occurs in the information technology infrastructure 110. In particular, the compliance management service may interact with the access manager 120, the identity vault 125, the synchronization engine 150, or any other suitable source that provides federated identity information to retrieve identities for the entities performing the operational activity, validate the identities, determine relationships between the identities, and otherwise map the identities to the operational activity. For example, in one implementation, the correlation system 165 may provide analytic services to process audit trails for any suitable resource 114 (e.g., correlating the audit trails and then mapping certain activities to identities for resources 114 involved in the activities). Furthermore, in response to the correlation system 165 processing the audit trails and determining that certain policies have been violated, the correlation system 165 may invoke one or more automated remediation workloads to initiate appropriate action for addressing the policy violations.

In one implementation, the compliance management service may further use the integrated policy definition service to monitor and report on the operational activity that occurs in the information technology infrastructure 110 and any policy evaluation determinations that the event audit service 135b generates through the policy definition service. For example, in one implementation, the workload engine 180a and/or the workload service 135b may retrieve information from a configuration management database 185a or other databases 155 that provide federated configuration information for managing the resources 114 in the information technology infrastructure 110. The workload engine 180a and/or the workload service 135b may therefore execute the compliance management service to perform scheduled and multi-step compliance processing, wherein the compliance processing may include correlating operational activities with identities and evaluating policies that may span various different policy domains in order to govern the information technology infrastructure 110. To that end, the model-driven architecture 100A and the service-oriented architecture 100B may provide various compliance management models may be used in the compliance management service.

In one implementation, the compliance management models may include a wrapped compliance management model that manages resources 114 lacking internal awareness over policy-based controls. The compliance management service may augment the resources 114 managed in the wrapped compliance model with one or more policy decision points and/or policy enforcement points that reside externally to the managed resources 114 (e.g., the event audit service 135b). For example, the policy decision points and/or the policy enforcement points may intercept any requests directed to the resources 114 managed in the wrapped compliance model, generate policy decisions that indicate whether the resources 114 can properly perform the requests, and then enforce the policy decisions (e.g., forwarding the requests to the resources 114 in response to determining that the resources 114 can properly perform the requests, denying the requests in response to determining that the resources 114 can properly perform the requests, etc.). Thus, because the resources 114 managed in the wrapped compliance model generally perform any requests that the resources 114 receive without considering policy-based controls or compliance issues, the event audit service 135b may further execute the compliance management service to wrap, coordinate, and synthesize an audit trail that includes data obtained from the managed resources 114 and the wrapping policy definition service.

In one implementation, the compliance management models may include a delegated compliance management model to manage resources 114 that implement a policy enforcement point and reference an external policy decision point, wherein the resources 114 managed in the delegated compliance management model may have limited internal awareness over policy-based controls. As such, in one implementation, the compliance management service may interleave policy decisions or other control operations generated by the external policy decision point with the internally implemented policy enforcement point to provide compliance assurance for the resources 114 managed in the delegated compliance management model. The delegated compliance management model may therefore represent a hybrid compliance model, which may apply to any suitable service that simultaneously anticipates compliance instrumentation but lacks internal policy control abstractions (e.g., the internally implemented policy enforcement point may anticipate the compliance instrumentation, while the externally referenced policy decision point has the relevant policy control abstractions). Thus, in the delegated compliance management model, the compliance management service may have fewer objects to coordinate than in the wrapped compliance management model, but the event audit service 135b may nonetheless execute the compliance management service to coordinate and synthesize an audit trail that includes data obtained from the managed resources 114 and the delegated external policy decision point.

In one implementation, the compliance management models may include an embedded compliance management model that manages resources 114 that internally implement policy enforcement points and policy decision points, wherein the resources 114 managed in the embedded compliance management model may have full internal awareness over policy-based controls. As such, in one implementation, the resources 114 managed in the embedded compliance management model may employ the internally implemented policy enforcement points and policy decision points to instrument any service and control operations for requests directed to the resources 114. In one implementation, to provide flexible compliance assurance, resources 114 managed in the embedded compliance management model may expose configuration or customization options via an externalized policy administration point. Thus, the embedded compliance management model may provide an integrated and effective audit trail for compliance assurance, which may often leave the compliance management service free to perform other compliance assurance processes.

Accordingly, in one implementation, the compliance management service may obtain information for any resource 114 managed in the information technology infrastructure 110 from the configuration management database 185a or other databases 155 that include a federated namespace for the managed resources 114, configurations for the managed resources 114, and relationships among the managed resources 114. In addition, the compliance management service may reference the configuration management database 185a or other the databases 155 to arbitrate configuration management in the infrastructure 110 and record previous configurations histories for the resources 114 in the configuration management database 185a or other databases 155. As such, the compliance management service may generally maintain information relating to identities, configurations, and relationships for the managed resources 114, which may provide a comparison context for analyzing subsequent requests to change the infrastructure 110 and identifying information technology services that the requested changes may impact.

Computing and Storage Environments

In one implementation, as noted above, the technologies integrated by the model-driven architecture 100A and the service-oriented architecture 100B may include managing computing and storage environments that support services in the infrastructure 110. In particular, in one implementation, the computing and storage environments used to support services in the infrastructure 110 may employ Linux operating environments, which may generally include an operating system distribution with a Linux kernel and various open source packages (e.g., gcc, glibc, etc.) that collectively provide the Linux operating environments. In one implementation, the Linux operating environments may generally provide a partitioned distribution model for managing the computing and storage environments employed in the workload management system. Further, in one implementation, a particular Linux distribution may be bundled for operating environments pre-installed in the workload management system (e.g., openSUSE, SUSE Linux Enterprise, etc.), which may enable vendors of physical hardware resources 114a to support every operating system that the vendors' customers employ without overhead that may introduced with multiple pre-installed operating environment choices.

In one implementation, the partitioned distribution model may partition the Linux operating environments into a physical hardware distribution (often referred to as a “pDistro”), which may include physical resources 114a that run over hardware to provide a physical hosting environment for virtual machines 114b. For example, in one implementation, the physical hardware distribution may include the Linux kernel and various hypervisor technologies that can run the virtual machines 114b over the underlying physical hosting environment, wherein the physical hardware distribution may be certified for existing and future-developed hardware environments to enable the workload management system to support future advances in the Linux kernel and/or hypervisor technologies. Alternatively (or additionally), the workload management system may release the physical hardware distribution in a full Linux distribution version to provide users with the ability to take advantage of future advances in technologies at a faster release cycle.

In one implementation, the partitioned distribution model may further partition the Linux operating environments into a virtual software distribution (often referred to as a “vDistro”), which may include virtual machines 114b deployed for specific applications or services that run, enable, and otherwise support workloads. More particularly, any particular virtual software distribution may generally include one or more Linux package or pattern deployments, whereby the virtual machines 114b may include virtual machines images with “just enough operating system” (JeOS) to support the package or pattern deployments needed to run the applications or services for the workloads. In one implementation, the virtual software distribution may include a particular Linux product (e.g., SUSE Linux Enterprise Server) bundled with hardware agnostic virtual drivers, which may provide configuration resources 114c for tuning virtualized resources 114b for optimized performance.

In one implementation, the particular virtual software distribution may be certified for governmental security requirements and for certain application vendors, which may enable the workload management system to update any physical resources 114a in the physical hardware distribution underlying the virtual software distribution without compromising support contracts with such vendors. In particular, in response to future changes in technology that may improve support for Linux operating environments, resulting improvements may occur in techniques for building and deploying Linux operating environments. Thus, where many application vendors currently tend to only provide support for certain Linux applications that run in certain Linux versions, the workload management system may enable support for any particular Linux application or version, which may drive Linux integration and adoption across the information technology infrastructure 110. In one implementation, for example, the workload management system may employ Linux applications and distributions created using a build system that enables any suitable application to be built and tested on different versions of Linux distributions (e.g., an openSUSE Build Service, SUSE Studio, etc.). For example, in response to receiving a request that includes unique specifications for a particular Linux application, the workload management system may notify distribution developers to include such specifications in the application, with the specifications then being made available to other application developers.

Thus, in one implementation, the Linux build system employed in the workload management system may enable distribution engineers and developers to detect whether changes to subsequent application releases conflict with or otherwise break existing applications. In particular, changes in systems, compiler versions, dependent libraries, or other resources 114 may cause errors in the subsequent application releases, wherein commonly employing the Linux build system throughout the workload management system may provide standardized application support. For example, in one implementation, the workload management system may employ certified implementations of the Linux Standard Base (LSB), which may enable independent software vendors (ISVs) to verify compliance, and may further provide various support services that can provide policy-based automated remediation for the Linux operating environments through the LSB Open Cluster Framework (OCF).

In one implementation, the Linux operating environments in the workload management system may provide engines that support orchestrated virtualization, collaboration, and architectural agility, as will be described in greater detail below. Further, to manage identities, enforce policies, and assure compliance, the Linux operating environments may include a “syslog” infrastructure that coordinate and manages various internal auditing requirements, while the workload management system may further provide an audit agent to augment the internal auditing capabilities that the “syslog” infrastructure provides (e.g., the audit agent may operate within the event audit service 135b to uniformly manage the Linux kernel, the identity services, the policy services, and the compliance services across the workload management system). For example, in one implementation, partitioning the monolithic Linux distribution within a multiple layer model that includes physical hardware distributions and virtual software distributions may enable each layer of the operating system to be developed, delivered, and supported at different schedules. In one implementation, a scheduling system 180c may coordinate such development, delivery, and support in a manner that permits dynamic changes to the physical resources 114a in the infrastructure 110, which provide stability and predictability for the infrastructure 110.

In one implementation, partitioning the Linux operating environments into physical hardware distributions and virtual software distributions may further enable the workload management system to run workloads in computing and storage environments that may not necessarily be co-located or directly connected to physical storage systems that contain persistent data. For example, the workload management system may support various interoperable and standardized protocols that provide communication channels between users, applications, services, and a scalable replicated storage system, such as the clustered file system 195 illustrated in FIG. 1A, wherein such protocols may provide authorized access between various components at any suitable layer within the storage system.

In one implementation, the clustered file system 195 may generally include various block storage devices, each of which may host various different file systems. In one implementation, the workload management system may provide various storage replication and version management services for the clustered file system 195, wherein the various block storage devices in the clustered file system 195 may be organized in a hierarchical stack, which may enable the workload management system to separate the clustered file system 195 from operating systems and collaborative workloads. As such, the storage replication and version management services may enable applications and storage services to run in cloud computing environments located remotely from client resources 115.

In one implementation, various access protocols may provide communication channels that enable secure physical and logical distributions between subsystem layers in the clustered file system 195 (e.g., a Coherent Remote File System protocol, a Dynamic Storage Technology protocol, which may provide a file system-to-file system protocol that can place a particular file in one of various different file systems based on various policies, or other suitable protocols). Furthermore, traditional protocols for access files from a client resource 115 (e.g., HTTP, NCP, AFP, NFS, etc.) may be written to file system specific interfaces defined in the definitive software library 190. As such, the definitive software library 190 may provide mappings between authorization and semantic models associated with the access protocols and similar elements of the clustered file system 195, wherein the mappings may be dynamically modified to handle any new protocols that support cross-device replication, device snapshots, block-level duplication, data transfer, and/or services for managing identities, policies, and compliance.

As such, the storage replication and version management services may enable users to create workloads that define identity and policy-based storage requirements, wherein team members identities may be used to dynamically modify the team members and any access rights defined for the team members (e.g., new team members may be added to a “write access” group, users that leave the team may be moved to a “read access” group or removed from the group, policies that enforce higher compliance levels for Sarbanes-Oxley may be added in response to an executive user joining the team, etc.). For example, a user that heads a distributed cross-department team developing a new product may define various members for the team and request permission for self-defined access levels for the team members (e.g., to enable the team members to individually specify a storage amount, redundancy level, and bandwidth to allocate). The workload management system may then provide fine grained access control for a dynamic local storage cache, which may move data stored in the in the clustered file system 195 to a local storage for a client resource 115 that accesses the data (i.e., causing the data to appear local despite being persistently managed in the clustered file system 195 remotely from the client resource 115). As such, individual users may then use information technology tools define for local area networks to access and update the data, wherein the replication and version management services may further enable the individual users to capture consistent snapshots that include a state of the data across various e-mail systems, databases 155, file systems 195, cloud storage environments, or other storage devices.

In one implementation, the storage replication and version management services may further enable active data migration and auditing for migrated data. For example, policies or compliance issues may require data to be maintained for a longer lifecycle than hardware and storage systems, wherein the workload management system may actively migrate certain data to long-term hardware or an immutable vault in the clustered file system 195 to address such policies or compliance issues. Furthermore, identity-based management for the data stored in the clustered file system 195 may enable the workload management system to control, track, and otherwise audit ownership and access to the data, and the workload management system may further classify and tag the data stored in the clustered file system 195 to manage the data stored therein (e.g., the data may be classified and tagged to segregate short-term data from long-term data, maintain frequently used data on faster storage systems, provide a content-addressed mechanism for efficiently searching potentially large amounts of data, etc.). Thus, the workload management system may use the storage replication and version management services to generate detailed reports 145 for the data managed in the clustered file system.

In one implementation, the storage replication and version management services may further provide replication services at a file level, which may enable the workload management system to control a location, an identity, and a replication technique (e.g., block-level versus byte-level) for each file in the clustered file system 195. In addition, the storage replication and version management services may further enable the workload management system to manage storage costs and energy consumption (e.g., by controlling a number of copies created for any particular file, a storage medium used to store such copies, a storage location used to store such copies, etc.). Thus, integrating federated identities managed in the identity vault 125 with federated policy definition services may enable the workload management system to manage the clustered file system 195 without synchronizing or otherwise copying every identity with separate identity stores associated with different storage subsystems.

Orchestrated Virtualization

In one implementation, as noted above, the technologies integrated by the model-driven architecture 100A and the service-oriented architecture 100B may provide orchestrated virtualization for managing services provided in the information technology infrastructure 110. In particular, virtualization generally ensures that a machine runs at optimal utilization by allowing services to run anywhere, regardless of requirements or limitations that underlying platforms or operating systems may have. Thus, the workload management system may define standardized partitions that control whether certain portions of the operating system execute over hardware provided in a hosting environment, or inside virtual machines 114b that decouple applications and services from the hardware on which the virtual machines 114b have been deployed. The workload management system may further employ a standardized image for the virtual machines 114b, provide metadata wrappers for encapsulating the virtual machines 114b, and provide various tools for managing the virtual machines 114b (e.g., “zero residue” management agents that can patch and update running instances of virtual machines 114b stored in the clustered file system 195, databases 155, or other repositories).

In one implementation, the virtualized services provided in the workload management system may simplify processes for developing and deploying applications, which may enable optimal utilization of physical resources 114a in the infrastructure. Furthermore, virtualization may be used to certify the Linux operating environments employed in the infrastructure 110 for any suitable platform that include various physical resources 114a. In particular, as described in further detail above, the workload management system may partition the Linux operating environments into a multiple-layer distribution that includes a physical distribution and a virtual distribution, wherein the physical distribution may represent a lower-level interface to physical resources 114a that host virtual machines 114b, while the virtual distribution may represent any applications or services hosted on the virtual machines 114b.

For example, in one implementation, the physical distribution may include a minimally functional kernel that bundles various base drivers and/or independent hardware vendor drivers matched to the physical resources 114a that host the virtual machines 114b. In one implementation, the physical distribution may further include a pluggable hypervisor that enables multiple operating systems to run concurrently over the hosting physical resources 114a, a minimal number of software packages that provide core functionality for the physical distribution, and one or more of the zero residue management agents that can manage any virtualized resources 114b that may be hosted on the physical resources 114a. As such, in response to any particular request to install a physical distribution, package selections available to the workload management system may include packages for the kernel, the hypervisor, the appropriate drivers, and the management agents that may be needed to support brands or classes of the underlying physical resources 114a.

Furthermore, in one implementation, the virtual distribution may include a tuned appliance, which may generally encapsulate an operating system and other data that supports a particular application. In addition, the virtual distribution may further include a workload profile encapsulating various profiles for certifying the appliance with attestation tokens (e.g., profiles for resources 114, applications, service level agreements, inventories, cost, compliance, etc.). Thus, the virtual distribution may be neutral with respect to the physical resources 114a included in the physical distribution, wherein the virtual distribution may be managed independently from any physical drivers and applications hosted by a kernel for the virtual distribution (e.g., upgrades for the kernels and physical device drivers used in the physical distributions may be managed independently from security patches or other management for the kernels and applications used in the virtual distributions). Thus, partitioning the physical distributions from the virtual distributions may remove requirements for particular physical resources 114a and preserve records for data that may require a specific application running on a specific operating system.

In one implementation, from a business perspective, the workload management system may secure the virtualized resources 114b in a similar manner as applications deployed on the physical resources 114a. For example, the workload management system may employ any access controls, packet filtering, or other techniques used to secure the physical resources 114a to enforce containment and otherwise secure the virtualized resources 114b, wherein the virtualized resources 114b may preserve benefits provided by running a single application on a single physical server 114a while further enabling consolidation and fluid allocation of the physical resources 114a. Furthermore, the workload management system may include various information technology tools that can be used to determine whether new physical resources 114a may be needed to support new services, deploy new virtual machines 114b, and establish new virtual teams that include various collaborating entities.

In one implementation, the information technology tools may include a trending tool that indicate maximum and minimum utilizations for the physical resources 114a, which may indicate when new physical resources 114a may be needed. For example, changes to virtual teams, different types of content, changes in visibility, or other trends for the virtualized resources 114b may cause changes in the infrastructure 110, such as compliance, storage, and fault tolerance obligations, wherein the workload management system may detect such changes and automatically react to intelligently manage that the resources 114 in the infrastructure 110. In one implementation, the information technology tools may further include a compliance tool providing a compliance envelope for applications running or services provided within any suitable virtual machine 114b. More particularly, the compliance envelope may save a current state of the virtual machine 114b at any suitable time and then push an updated version of the current state to the infrastructure 110, whereby the workload management system may determine whether the current state of the virtual machine 114b complies with any policies that may have been defined for the virtual machine 114b. For example, the workload management system may support deploying virtual machines 114b in demilitarized zones, cloud computing environments, or other data centers that may be remote from the infrastructure 110, wherein the compliance envelope may provide a security wrapping to safely move such virtual machines 114b and ensure that only entities with approved identities can access the virtual machines 114b.

Thus, from an architectural perspective, the virtualized resources 114b may enable the workload management system to manage development and deployment for services and applications provisioned in the infrastructure 110. For example, rather than dynamically provisioning physical resources 114a to deal with transient peaks in load and availability on a per-service basis, which may result in under-utilized physical resources 114a, the workload management system may host multiple virtual machines 114b on one physical machine 114a to optimize utilization levels for the physical resources 114a, which may dynamically provisioned physical resources 114a that enable mobility for services hosted in the virtual machines 114b. Thus, in one implementation, mobile services may enable the workload management system to implement live migration for services that planned maintenance events may impact without adversely affecting an availability of such services, while the workload management system may implement clustering or other availability strategies to address unplanned events, such as hardware or software failures.

In one implementation, the workload management system may further provide various containers to manage the virtual machines 114b, wherein the containers may include a security container, an application container, a service level agreement container, or other suitable containers. The security container may generally provide hardware-enforced isolation and protection boundaries for various virtual machines 114b hosted on a physical resource 114a and the hypervisor hosting the virtual machines 114b. In one implementation, the hardware-enforced isolation and protection boundaries may be coupled with a closed management domain to provide a secure model for deploying the virtual machines 114b (e.g., one or more security labels can be assigned to any particular virtual machine 114b to contain viruses or other vulnerabilities within the particular virtual machine 114b). Furthermore, in the context of tuned appliances, wherein one virtual machine 114b hosts one service that supports one particular application, the application container may package the service within a particular virtual machine image 114b. As such, the virtual machine image 114b may include a kernel and a runtime environment optimally configured and tuned for the hosted service. Similarly, the service level agreement container may dynamically monitor, meter, and allocate resources 114 to provide quality of service guarantees on a per-virtual machine 114b basis in a manner transparent to the virtual machine kernel 114b.

In one implementation, the various containers used to manage the virtual machines 114b may further provide predictable and custom runtime environments for virtual machines 114b. In particular, the workload management system may embed prioritization schemes within portions of an operating system stack associated with a virtual machine 114b that may adversely impact throughput in the operating system. For example, unbounded priority inversion may arise in response to a low-priority task holding a kernel lock and thereby blocking a high-priority task, resulting in an unbounded latency for the high-priority task. As such, in one implementation, the prioritization schemes may embed a deadline processor scheduler in the hypervisor of the virtual machine 114b and build admission control mechanisms into the operating system stack, which may enable the workload management system to distribute loads across different virtual machine 114b and support predictable computing. In addition, the workload management system may decompose kernels and operating systems for virtual machines 114b to provide custom runtime environments. For example, in the context of a typical virtual machine 114b, an “unprivileged guest” virtual machine 114b may hand off processing to a “helper” virtual machine 114b at a device driver level. Thus, to support server-class applications that may depend on having a portable runtime environment, the workload management system may use the decomposed kernels and operating systems to dynamically implement an operating system for a particular virtual machine 114b at runtime (e.g., the dynamically implemented operating system may represent a portable runtime that can provide a kernel for a virtual machine 114b that hosts a service running a server-class application, which may be customized as a runtime environment specific to that service and application).

In one implementation, the workload management system may further employ different virtualization technologies in different operating environments. For example, in one implementation, the workload management system may implement Type 1 hypervisors for virtualized server resources 114b and Type 2 hypervisors for virtualized workstation, desktop, or other client resources 115. In particular, Type 1 hypervisors generally control and virtualize underlying physical resources 114a to enable hosting guest operating systems over the physical resources 114a (e.g., providing coarse-level scheduling to partition the physical resources 114a in a manner that can meet quality of service requirements for each of the guest operating systems hosted on the physical resources 114a). Thus, the workload management system may implement Type 1 hypervisors for virtualized server resources 114b to leverage performance and fault isolation features that such hypervisors provide. In contrast, Type 2 hypervisors generally include use a host operating system as the hypervisor, which use Linux schedulers to allocate resources 114 to guest operating systems hosted on the hypervisor. In Type 2 hypervisor architectures, such as the VMware GSX Server, Microsoft Virtual PC, and Linux KVM, hosted virtual machines 114b appear as a process similar to any other hosted process. Thus, because workstations, desktops, and other client resources 115 may include hardware that may or may not support virtualization, the workload management system may provide centralized desktop management and provisioning using Type 2 hypervisors. For example, the workload management system may manage and maintain desktop environments as virtual appliances 114b hosted in the infrastructure 110 and then remotely deliver the desktop environments to remote client resources 115 (e.g., in response to authenticating an end user at a particular client resource 115, the virtual appliance 114b carrying the appropriate desktop environment may be delivered for hosting to the client resource 115, and the client resource 115 may transfer persistent states for the desktop environment to the infrastructure 110 to ensure that the client resource 115 remains stateless).

In one implementation, orchestrated virtualization may generally refer to implementing automated policy-based controls for virtualized services. For example, an orchestrated data center may ensure compliance with quality of service agreements for particular groups of users, applications, or activities that occur in the information technology infrastructure 110. The workload management system may therefore provide a policy-based orchestration service to manage virtualized resources 114b, wherein the orchestration service may gather correct workload metrics without compromising performance in cloud computing environments or other emerging service delivery models. For example, workloads that users define may be executed using coordinated sets of virtual machines 114b embedding different application-specific operating systems, wherein the workload management system may provision and de-provision the virtual machines 114b to meet requirements defined in the workload (e.g., using standard image formats and metadata wrappers to encapsulate the workloads, embed standard hypervisors in the virtual machines 114b, physical-to-virtual (P2V) or virtual-to-virtual (V2V) conversion tools to translate between different image formats, etc.). Furthermore, in cloud computing environments that can include unpredictable sets of dynamic resources external to the infrastructure 110, the workload management system coordinate such resources using a closed-loop management infrastructure 170 that manages declarative policies, fine-grained access controls, and orchestrated management and monitoring tools.

In one implementation, the workload management system may further manage the orchestrated data center to manage any suitable resources 114 involved in the virtualized workloads, which may span multiple operating systems, applications, and services deployed on various physical resources 114a and/or virtualized resources 114b (e.g., a physical server 114a and/or a virtualized server 114b). Thus, the workload management system may balance resources 114 in the information technology infrastructure 110, which may align management of resources 114 in the orchestrated data center with business needs or other constraints defined in the virtualized workloads (e.g., deploying or tuning the resources 114 to reduce costs, eliminate risks, etc.). For example, as described in further detail above, the configuration management database 185a may generally describe every resource 114 in the infrastructure 110, relationships among the resources 114, and changes, incidents, problems, known errors, and/or known solutions for managing the resources 114 in the infrastructure 110.

As such, the policy-based orchestration service may provide federated information indexing every asset or other resource 114 in the infrastructure 110, wherein the workload management system may reference the federated information to automatically implement policy-controlled best practices (e.g., as defined in the Information Technology Infrastructure Library) to manage changes to the infrastructure 110 and the orchestrated data center. For example, the configuration management database 185a may model dependencies, capacities, bandwidth constraints, interconnections, and other information for the resources 114 in the infrastructure 110, which may enable the workload management system to perform impact analysis, “what if” analysis, and other management functions in a policy-controlled manner. Furthermore, as noted above, the configuration management database 185a may include a federated model of the infrastructure 110, wherein the information stored therein may originate from various different sources. Thus, through the federated model, the configuration management database 185a may appear as one “virtual” database incorporating information from various sources without introducing overhead otherwise associated with creating one centralized database that potentially includes large amounts of duplicative data.

In one implementation, the orchestration service may automate workloads across various physical resources 114a and/or virtualized resources 114b using policies that match the workloads to suitable resources 114. For example, deploying an orchestrated virtual machine 114b for a requested workload may include identifying a suitable host virtual machine 114b that satisfies any constraints defined for the workload (e.g., matching tasks to perform in the workload to resources 114 that can perform such tasks). In response to identifying allocating and deploying the suitable host virtual machine 114b, deploying the orchestrated virtual machine 114b for the workload may include the workload management system positioning an operating system image on the host virtual machine 114b, defining and running the orchestrated virtual machine 114b on the chosen host virtual machine 114b, and then monitoring, restarting, or moving the virtual machine 114b as needed to continually satisfy the workload constraints.

In one implementation, the orchestration service may include various orchestration sub-services that collectively enable management over orchestrated workloads. For example, the orchestration service may be driven by a blueprint sub-service that defines related resources 114 provisioned for an orchestrated workload, which the workload management system may manage as a whole service including various different types of resources 114. Furthermore, a change management sub-service may enable audited negotiation for service change requests, including the manner and timing for committing the change requests (e.g., within an approval workload 130). The sub-services may further include an availability management sub-service that can control and restart services in a policy-controlled manner, a performance management sub-service that enforces runtime service level agreements and policies, a patch management sub-service that automatically patches and updates resources 114 in response to static or dynamic constraints, and a capacity management sub-service that can increase or reduce capacities for resources 114 in response to current workloads.

To provide exemplary contexts for some of the orchestration sub-services noted above, the availability management sub-service may automatically migrate a virtual machine 114b to another physical host 114a in response to a service restart failing on a current physical host 114a more than a policy-defined threshold number of times. With respect to the performance management sub-service, in response to determining that a service running at eighty percent utilization can be cloned, the service may be cloned to create a new instance of the service and the new instance of the service may be started automatically. Furthermore, to manage a patch for running instances of a service, the patch management sub-service may test the patch against a test instance of the service and subsequently apply the patch to the running service instance in response to the test passing. Regarding the capacity management sub-service, an exemplary service instance may include a service level agreement requiring a certain amount of available storage for the service instance, wherein the capacity management sub-service may allocate additional storage capacity to the service instance in response to determining that the storage capacity currently available to the service instance has fallen below a policy-defined threshold (e.g., twenty percent).

In one implementation, the orchestration service may incorporate workflow concepts to manage approval workloads 130 or other management workloads, wherein a workload database 185b may store information that the workload management system can use to manage the workloads. For example, in one implementation, an approval workload 130 may include a request to provision a particular service to a particular user in accordance with particular constraints, wherein the approval workload 130 may include a sequence of activities that includes a suitable management entity reviewing the constraints defined for the service, determining whether any applicable policies permit or prohibit provisioning the service for the user, and deploying the service in response to determining that the service can be provisioned, among other things. Thus, the workload engine 180a may execute the orchestration service to map the sequence of activities defined for any particular workload to passive management operations and active dynamic orchestration operations. For example, the workload database 185b may stores various declarative service blueprints that provide master plans and patterns for automatically generating service instances, physical distribution images and virtual distribution images that can be shared across the workload management system to automatically generate the service instances, and declarative response files that define packages and configuration settings to automatically apply to the service instances.

Collaboration

In one implementation, as noted above, the technologies integrated by the model-driven architecture 100A and the service-oriented architecture 100B may enable collaboration between entities that interact with the services provided in the information technology infrastructure 110. In particular, collaboration may generally involve dynamic teams that cross traditional security and policy boundaries. For example, where loosely affiliated organizations share data and applications, the workload management system may enable continued collaboration even when some of the participants sharing the data and applications may be temporarily offline (e.g., the workload management system may authorize certain users to allocate portions of local client resources 115 to support cross-organizational endeavors). Thus, the workload management system may provide a standard interface 160 designed to enable dynamic collaboration for end users that simplify interaction with complex systems, which may provide organizations with opportunities for more productive and agile workloads.

In one implementation, the workload management system may provide a collaboration service that enables workloads to span multiple users, applications, services, systems, or other resources 114. For example, multiple users may collaborate and share data and other resources 114 throughout the workload management system, both individually and within virtual teams (e.g., via a service bus that transports data relating to services or other resources 114 over the event bus 140). As such, the workload management system may support virtual team creation that can span organizational and geographic boundaries, wherein affiliations, content, status, and effectiveness may be represented for identities that have membership in any particular virtual team (e.g., to enable online and offline interaction between team members). In one implementation, the workload management system may provide enriched collaboration content (e.g., images, video, text, data feeds), and may efficiently transport the collaboration content between team members (e.g., via the service bus). Furthermore, the workload management system may integrate desktops, laptops, personal digital assistants, smart phones, or other suitable client resources 115 into virtual team collaboration experiences in order to meet emerging demands for mobile, interoperable, and integrated access. Thus, the collaboration enabled in the workload management system may operate in an adaptive collaborative environment, which may unify technologies for online integrated media sharing with offline authoring and editing.

In one implementation, the collaboration service may generally include a web-based platform that support inter-organization and intra-organization management for virtual teams, interoperability between various different collaboration products, social networking to deliver information that enables the virtual teams to interact efficiently either online or offline, and federated searches against any suitable information source, among other things. For example, in one implementation, the collaboration service may include various collaboration sub-services that collectively enable the adaptive collaborative environment, including a client sub-service, an aggregation sub-service, an information sub-service, a real-time collaboration sub-service, and a metadata sub-service.

In one implementation, the client sub-service may provide communication interfaces with real-time online systems, offline systems, and user interfaces. In particular, functionality for the client sub-service may be provided in a web-based interface that supports interaction with the real-time online systems in addition to software that can execute locally at client resources 115 to provide offline access to shared data and real-time meetings that may involve shared applications and shared desktops. For example, in one implementation, the client sub-service may communicate with the aggregation sub-service to coordinate the communication and collaboration across various information sources, wherein the aggregation sub-service may route messages to the appropriate information sources in appropriate formats. Furthermore, to ensure that collaborative contexts reference information that may be distributed across the infrastructure 110 rather than hosted within one particular application, the information sub-service may integrate the different information sources within the collaborative environment. As such, the virtual teams may connect and collaborate using information that originates anywhere across the infrastructure 110, and the information sub-service may enable members of the virtual teams to discuss information or other content from the various sources in an interactive manner. The real-time collaboration sub-service may interact with the information sub-service to provide real-time meetings that include audio content, video content, instant message content, and other forms of communication content in real-time collaborative contexts within the infrastructure 110 and with third-parties.

In one implementation, the metadata sub-service may provide a “helper” service to the aggregation and information sub-services, collecting ancillary metadata generated during interaction between virtual team members and create collaborative threads to maintain contexts that generated the data. Furthermore, the metadata sub-service may evaluate the ancillary metadata to discover new and relevant links between information sources and integrate data that can potentially originate from various disparate information sources. For example, the metadata sub-service may provide a uniform format for classifying data collected during collaborative contexts, which may provide a single source for virtual team members to search and display the data across any suitable collaboration source. Similarly, the metadata sub-service may index and unify data collected from disparate network sources, including various search engines and content aggregation services, to help the virtual team members to locate information that may be interesting or otherwise relevant to the collaborative contexts. As such, the various sub-services integrated within the collaboration service may provide a collaborative environment that supports dynamic interaction across organizational boundaries and different information sources in a manner that can account for any particular virtual team member's personal preferences.

Architectural Agility

In one implementation, as noted above, the technologies integrated by the model-driven architecture 100A and the service-oriented architecture 100B may collectively provide various services that the workload management system can use to manage workloads and enable intelligent choices in an information technology infrastructure 110. Furthermore, various horizontal integration components may be distributed in the workload management system to integrate the various technologies employed in the model-driven architecture 100A and the service-oriented architecture 100B and provide an agile and interoperable information technology infrastructure 110.

In particular, the horizontal integration components distributed across the workload management system may provide agility and interoperability to the information technology infrastructure 110 through support for various emerging service delivery models, including Web 2.0, Software as a Service (SaaS), mashups, hardware, software, and virtual appliances, cloud computing, grid computing, and thin clients, among others. For example, in one implementation, every service, application, or other resource 114 in the workload management system may be provided with an application programming interface 160 that can provide connectivity between different operating systems, programming languages, graphical user interface toolkits, or other suitable services, applications, or resources 114.

In one implementation, the application programming interface 160 may include a Representational State Transfer (REST) application program interface 160, which may use standard methods defined in the Hypertext Transfer Protocol (HTTP), wherein using standardized types to format data may ensure interoperability. In one implementation, the REST interface 160 may define a Uniform Resource Identifier (URI) that represents a unique identity for any suitable entity, and may further define relationships between the represented identities with hyperlinks that can be selected to access information for related identities, attribute claims, roles, policies, workloads, collaboration spaces, and workflow processes. Thus, through the use of URIs, hyperlinks, and other standard HTTP methods, the REST interface 160 may provide an interface to a data ecosystem that can be navigated in a web-based environment that can be used anywhere in the workload management system. In one implementation, the REST interface 160 may declare a namespace having version controls and standard methods to read and write to the data ecosystem, and may include a URI registry containing the URIs that represent the identities in the data ecosystem. Thus, any suitable resource 114 may programmatically discover other identities that communicate using the REST interface 160 (e.g., the REST interface 160 may be implemented in a communication gateway 112a to physical resources 114a, a communication gateway 112b to virtualized resources 114a, a communication gateway 112c to configuration resources 114c, etc.).

Furthermore, in one implementation, the workload management system may extend an application program interface stack for the supplied REST interface 160, which may enable new services, applications, and other resources 114 to be integrated into the workload management system in a manner that automatically inherits the identity-based and policy-controlled services implemented in the workload management system. In particular, the supplied application program interface stack may generally include a unified adapter and a proxy to existing and future technologies using protocols to enable services that communicate through the REST interface 160 regardless of whether the services reside in the infrastructure 110, a cloud computing environment, a third party data center, or elsewhere (e.g., web service protocols, lightweight directory protocols, messaging queue protocols, remote procedure call protocols, etc.). To provide support to developers and users that extend the application program interface stack supplied for the REST interface 160, a Recipe-based Development Kit (RDK) may provide full source code examples for various operating systems, programming languages, and graphical user interface toolkits.

Additionally, in one implementation, the workload engine 180a may manage creation of application program interface keys for the REST interface 160 stack, whereby auditing and policy-based approvals may be supported for provisioning the application program interface keys. For example, the workload management system may deploy widgets to client desktops 115, wherein the widget may track identities and contexts that include attempts to access the REST interface 160 stack. Thus, in response to provisioning or auditing application program interface keys, platform authentication and policy checks may be triggered against the accessing identity and the context that the keys supply. In a similar manner, the application program interface keys may enable the workload management system to meter costs for the information technology infrastructure 110.

Thus, the standardized stack supplied for the REST application program interface 160 may provide support for industry standard authentication and authorization methods, which may enable identity-managed and policy-controlled auditing for events and access controls. Furthermore, the extensibility of the REST application program interface 160 may enable integration with any suitable existing or future-developed system. For example, in one implementation, the REST interface 160 may be configured with standards such as the Atom Syndication Format and Atom Publishing Protocol to integrate feed synchronization, JavaScript Object Notation and Extensible Markup Language (XML) to integrate enterprise portals, mashups, and social networking platforms. Thus, in the context of feed synchronization to provide automatically notifications in response to any changes to a particular resource 114, a user may simply enter a URI for the resource 114 in an existing web browser feed aggregator (e.g., Firefox bookmarks). Thus, by providing extensible support for any suitable system, application, service, or other resources 114, the features of the REST application program interface 160 may provide agility and interoperability to the infrastructure 110.

Having described the model-driven and service-oriented architecture 100A-B that collectively provide the agile, responsive, reliable, and interoperable environment that enables the features of the workload management system, the description to be provided below will address certain particular features of the workload management system. In addition, further detail relating to the architectural foundation and other features of the workload management system may be provided in “Novell Architectural Foundation: A Technical Vision for Computing and Collaborating with Agility,” “Automation for the New Data Center,” and “A Blueprint for Better Management from the Desktop to the Data Center,” the contents of which are hereby incorporated by reference in their entirety.

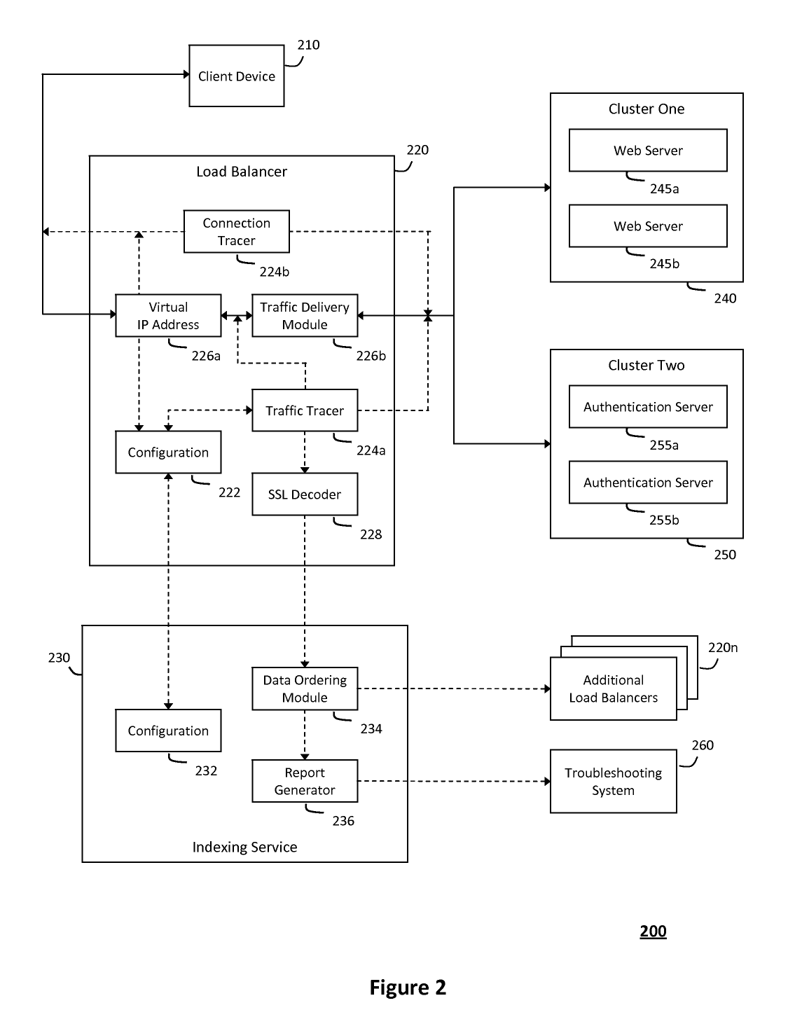

According to one aspect of the invention, FIG. 2 illustrates an exemplary system 200 that provides load balancer visibility in the intelligent workload management system shown in FIG. 1A and FIG. 1B. In particular, the system 200 illustrated in FIG. 2 may generally expand a role or function that a load balancer 220 provides to manage incoming and outgoing traffic in a data center managed with the workload management system, wherein the role or function that the load balancer 220 provides may expanded to support the governance, risk, and compliance concerns that can be managed in the workload management system with the techniques described in further detail above in connection with FIG. 1A and FIG. 1B. For example, in one implementation, the load balancer 220 may generally balance loads associated with routing and delivering incoming and outgoing traffic in the data center, and the load balancer 220 may further include functionality that can collect management data from the incoming and outgoing traffic while balancing the loads associated therewith (e.g., the management data collected with the load balancer 220 may describe user identities, access credentials, services, applications, physical and virtualized information technology resources, or any other relevant management data associated with the incoming and outgoing traffic). As such, the functionality that the load balancer 220 includes to collect the management data may provide a governance, risk, and compliance solution that can be used to manage workloads associated with any suitable client device 210 or application that uses the load balancer 220.

In one implementation, the system 200 shown in FIG. 2 may therefore expand the role or function that the load balancer 220 provides to provide visibility into all incoming and outgoing traffic routed through the load balancer 220, which may provide further control over the data center and thereby support the governance, risk, and compliance concerns that the workload management system addresses. In particular, the load balancer 220 may include various components that can provide visibility into traffic directed into the data center and traffic directed out of the data center, which may enable the workload management system to track activity that any suitable application or user may be performing from the incoming and outgoing traffic that the load balancer 220 routes and balances. Moreover, because the load balancer 220 can collect management data describing user identities, credentials, services, applications, information technology resources, and other data center management aspects from the incoming and outgoing traffic while balancing the loads associated therewith, the system 200 may provide troubleshooting, auditing, logging, and other tools that can be used to manage the data center without substantially impacting workload performance.

For example, in one implementation, cookies, session data, or other identifiers may be added to the incoming and outgoing traffic that traverses the load balancer 220, wherein the load balancer 220 may use the cookies, session data, or other identifiers to balance loads associated with the incoming and outgoing traffic (e.g., the load balancer 220 may use SYN cookies and delayed binding to prevent denial of service attacks, associate a particular session between a client device 210 and a particular web server 245a in a server cluster 240 with a cookie that provides “stickiness” between the client device 210 and the particular web server 245a, etc.). In one implementation, the identifiers added to the incoming and outgoing traffic may then be used to organize and control data that the load balancer 220 collects from the incoming and outgoing traffic using one or more traffic tracers 224a. In particular, as will be described in further detail herein, the traffic tracers 224a may conduct an entire trace for any incoming or outgoing traffic that the load balancer 220 handles, apply various rules and filters to the data collected from the incoming and outgoing traffic, and insert one or more connection tracers 224b into the incoming and outgoing traffic stream to provide further functionality that can support governance, risk, and compliance in the workload management system.

Having generally described the functionality associated with the system 200, the description provided herein will address certain exemplary components and features that the system 200 may include to provide visibility into the incoming and outgoing traffic streams that the load balancer 220 handles, which may support the governance, risk, and compliance concerns addressed in the workload management system. Furthermore, although the description to be provided herein addresses one particular load balancer 220, the system 200 can suitably scale to provide visibility into multiple load balancers 220n that may be located in multiple different data centers (e.g., a particular load balancer 220n may be distributed within a firewall to provide visibility into traffic that passes through the firewall). As such, the system 200 may generally monitor and track any suitable traffic that enters or leaves the data centers.

In one implementation, a client device 210 may originate a request that the system 200 may then deliver to the load balancer 220. In one implementation, the load balancer 220 may then assign the client device 210 a virtual Internet Protocol (IP) address 226a, which the load balancer 220 may use to route incoming and outgoing traffic associated with the client device 210. For example, in one implementation, the load balancer 220 may include the virtual IP address 226a assigned to the client device 210 in any outgoing traffic that the load balancer 220 communicates to a first server cluster 240, a second server cluster 250, or other external sources in order to handle the request received from the client device 210. As such, any incoming traffic that the first server cluster 240, the second server cluster 250, or the other external sources communicate to the load balancer 220 in response to the request may be directed to the virtual IP address 226a that the load balancer 220 included in the outgoing traffic, whereby the load balancer 220 may redirect such incoming traffic to a physical network interface associated with the client device 210. Accordingly, assigning the virtual IP address 226a to the client device 210 may provide connection redundancy in the load balancer 220 because the virtual IP address 226a may remain available in scenarios where the incoming traffic cannot be redirected to the physical network interface associated with the client device 210 (e.g., if delivering the traffic to the physical network interface or the client device 210 fails). In one implementation, the load balancer 220 may therefore include a traffic delivery module 226b that passes the incoming and outgoing traffic through the load balancer 220 (i.e., the outgoing traffic passing through the load balancer 220 may originate from the client device 210, while the incoming traffic passing through the load balancer 220 may be directed to the client device 210). Additionally, in one implementation, an indexing service 230 may include one or more configurations 232 to define relationships that the traffic delivery module 226 uses to route or otherwise deliver traffic originating from or directed to certain virtual IP addresses 226a. In one implementation, the load balancer 220 may read the configuration 232 from the indexing service 230 into a configuration 222 locally associated with the load balancer 220, wherein the configuration 222 read from the indexing service 230 may then be passed to the one or more traffic tracers 224a.

In one implementation, the traffic tracers 224a may reference the configuration 222 defining the relationships that the traffic delivery module 226 uses to deliver traffic originating from or directed to certain virtual IP addresses 226a to attach connection tracers 224b into any internal or external connections with the load balancer 220, wherein the connection tracers 224b may attach cookies, session identifiers, headers, or other identifying data to the internal or external connections with the load balancer 220, wherein the particular identifying data may depend on a particular communication protocol used in the internal and external connections. For example, the client device 210 may establish an internal connection with the load balancer 220 to communicate with web servers 245 in the first server cluster 240 using Transmission Control Protocol (TCP), and further to communicate with authentication servers 255 in the second server cluster 250 using Secure Socket Layer (SSL), and the traffic delivery module 226b may then establish external connections with the first server cluster 240 and the second server cluster 250 to establish a TCP session between the client device 210 and the web servers 245 in the first server cluster 240 and an SSL session between the client device 210 and the authentication servers 255 in the second server cluster 250. As such, the connection tracers 224b may attach cookies, session identifiers, headers, or other suitable data to identify the internal connection that the client device 210 established with the load balancer 220 and the external sessions that the traffic delivery module 226b established with the first server cluster 240 and the second server cluster 250. Furthermore, in response to the traffic delivery module 226b in the load balancer 220 receiving any incoming traffic directed to the client device 210, the traffic tracers 224b may similarly attach connection tracers 224b into one or more connections returning the traffic to the load balancer 220 to trace incoming connections directed back to the client device 210.

In one implementation, the traffic tracers 224a may further collect data describing any traffic that the internal and external connections then pass through the load balancer 220. In particular, as noted above, the connection tracers 224b may attach cookies, session identifiers, headers, or other suitable data to identify the internal and external sessions with the load balancer 220, wherein the connection tracers 224b may notify the traffic tracers 224a in response to detecting any traffic passing through the load balancer 220 in the internal and external connections. As such, in response to the traffic tracers 224a receiving the notification that the internal and external connections are passing traffic through the load balancer 220, the traffic tracers 224a may collect data describing the traffic (e.g., via the dashed lines connected to the traffic tracers 224a in FIG. 2). Furthermore, in one implementation, the traffic tracers 224a may reference the configuration 222 read from the indexing service 230 to apply one or more heuristics, filters, and other rules to the data collected from the traffic that the internal and external connections pass through the load balancer 220. In particular, the configuration 222 may define certain identity controls, policies, service level agreements, or other criteria that define relevant management data to collect from the traffic passing through the load balancer 220, wherein the traffic tracers 224a may apply the heuristics, filters, and other rules to normalize, organize, or otherwise control the nature of the data collected from the traffic passing through the load balancer 220. For example, as shown in FIG. 2, the client device 210 may communicate with multiple server clusters (i.e., web server cluster 240 and authentication server cluster 250), whereby having the traffic tracers 224a and the connection tracers 224b monitor the traffic and connections with the load balancer 220 and apply the heuristics, filters, and other rules may be used to distinguish a particular web server 245 in cluster 240 that responded to the request from the client device 210 and a particular authentication server 255 in cluster 250 that responded to the request from the client device 210.

In one implementation, the load balancer 220 may further include an SSL decoder 228 that can decode messages within the incoming and traffic that include encrypted SSL data. In particular, SSL may be used to encrypt one or more segments within the connections that pass traffic through the load balancer 220 to provide secure transit for sensitive data. As such, in response to the traffic tracers 224a applying the heuristics, filters, and other rules to the data collected from the traffic and determining that the collected data includes one or more encrypted SSL messages, the SSL decoder 228 may be invoked to decode the message and further apply the heuristics, filters, and other rules to the decoded message in order to collect relevant management data. Furthermore, in one implementation, the traffic tracers 224a may initially apply the heuristics, filters, and other rules to determine whether or not to decode the encrypted messages (e.g., any encrypted messages that include personal data may not be decoded to protect user privacy, whereas encrypted messages directed to an application that interacts with corporate data may be decoded to provide a governance, risk, and compliance audit trail). Furthermore, although FIG. 2 and the description provided herein indicates that the decoder 228 operates on encrypted SSL data, the decoder 228 may be suitably modified (or supplemented) to handle messages encoded with any other suitable communication protocol, whether or not explicitly described.

In one implementation, in response to the traffic tracers 224a applying the heuristics, filters, and other rules to the data collected from the traffic passing through the load balancer 220, the resulting data may then be provided to a data ordering module 234 located within the indexing service 230, wherein the data ordering module 234 may order the resulting data according to time, content, or other suitable criteria. In one implementation, the data ordering module 234 may employ any suitable technique to order the data collected with the traffic tracers 224a and provided to the indexing service 230, and may then store the ordered data in one or more databases or other suitable repositories. Furthermore, in one implementation, depending on the size and complexity of the ordered data, the indexing service 230 may be distributed or otherwise separated into multiple components (e.g., ordered data that must be persistently retained to demonstrate compliance may be stored in a replicated file system that provides failover redundancy, large data sets that have substantial storage requirements may be stored in a clustered file system that has substantial storage capacity, etc.).

In one implementation, the ordered data may then be analyzed with a report generator 236 that describes any relevant governance, risk, and compliance data associated with the incoming and outgoing traffic that passed through the load balancer 220. In particular, the report generator 236 may be configured with one or more requirements that define the relevant governance, risk, and compliance issues that may apply to the incoming and outgoing traffic that passed through the load balancer 220, whereby the report generator 226 may analyze the data ordered with the data ordering module 234 in view of the defined requirements to report on the incoming and outgoing traffic that passed through the load balancer 220. For example, the report generator 236 may be configured with requirements that all traffic delivered to a particular web server 245a from client devices 210 located in the United Kingdom, in which case the report generator 236 may analyze the ordered data to identify any traffic that client devices 210 located in the United Kingdom communicated to the particular web server 245a. As such, the report may then be sent to a troubleshooting system 260 or any other suitable system or application that may require the report (e.g., in response to a particular problem in the data center, the troubleshooting system 260 may provide one or more requirements associated with the problem to the indexing service 230, whereby the report generator 236 may be configured to report data that can be used to troubleshoot the particular problem). Accordingly, the workload management system may generally obtain any suitable management data from the system 200 in order to manage incoming and outgoing traffic that passes through the load balancer 220.

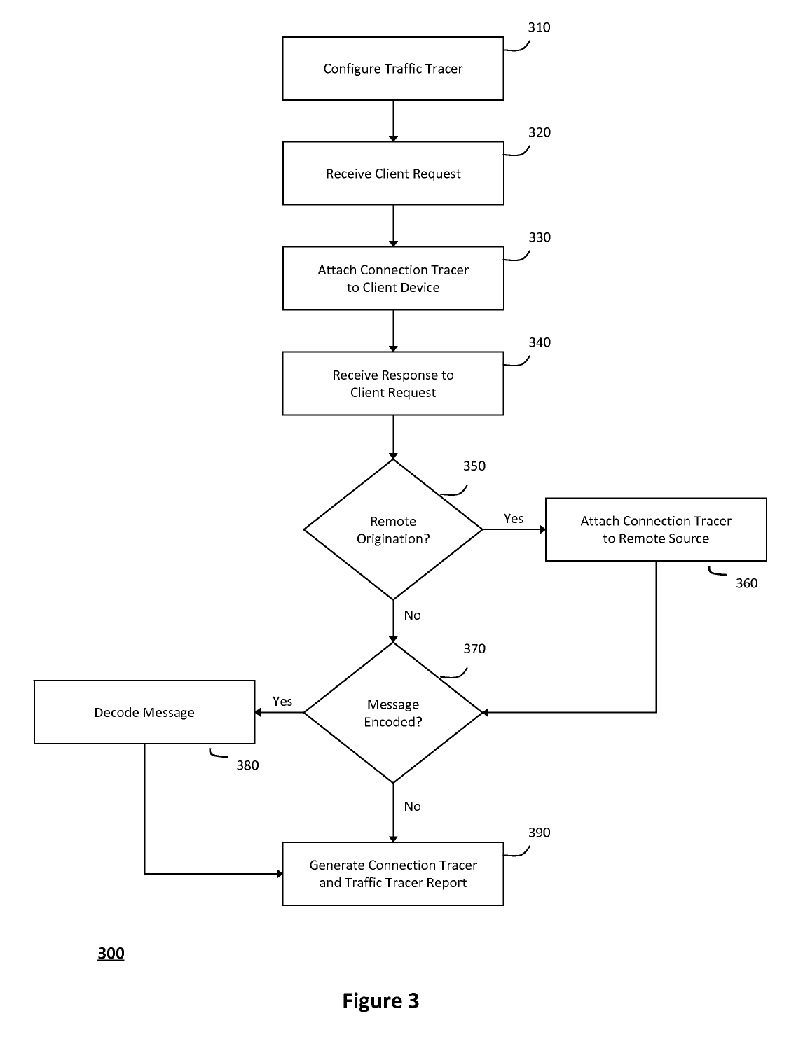

According to one aspect of the invention, FIG. 3 illustrates an exemplary method 300 that provides load balancer visibility in the intelligent workload management system shown in FIG. 1A and FIG. 1B. In particular, the method 300 illustrated in FIG. 3 may generally operate in the system shown in FIG. 2 and described in further detail above, wherein one or more traffic tracers may be configured in an operation 310 to monitor traffic associated with a client request, which may be received at a load balancer in an operation 320. In one implementation, in response to receiving the request from the client device, the load balancer may assign a virtual network address to the client device, which the load balancer may use to route incoming and outgoing traffic associated with the client device. For example, the load balancer may include the virtual network address assigned to the client device in any outgoing traffic that the load balancer communicates to destination resources in order to handle the request received from the client device. As such, any incoming traffic that the destination resources subsequently communicate to the load balancer in response to the request may be directed to the virtual network address that the load balancer included in the outgoing traffic, whereby the load balancer may redirect such incoming traffic to a physical network interface associated with the client device. Accordingly, assigning the virtual network address to the client device in operation 320 may provide connection redundancy in the load balancer (e.g., because the virtual network address may remain available in scenarios where the incoming traffic cannot be redirected to the physical network interface associated with the client device).

In one implementation, the load balancer may include a traffic delivery module that handles passing the incoming and outgoing traffic through the load balancer (i.e., outgoing traffic originating from the client device, incoming traffic directed to the client device, etc.). In addition, an indexing service may include one or more configurations that define relationships used in the traffic delivery module to route or otherwise deliver traffic originating from or directed to certain virtual network addresses. Thus, in one implementation, operation 310 may further include the load balancer reading the configuration from the indexing service and then passing the configuration read from the indexing service to the traffic tracers, which may configure the traffic tracers to monitor the incoming and outgoing traffic passing through the load balancer. In one implementation, the traffic tracers may generally reference the configuration that defines the relationships used to deliver traffic passing through the load balancer in order to attach connection tracers into any internal or external connections that deliver the traffic to the load balancer. For example, in one implementation, the connection tracers may attach cookies, session identifiers, headers, or other identifiers associated with particular communication protocols into the internal or external connections that deliver the traffic to the load balancer.

For example, in one implementation, the client device may establish an internal connection with the load balancer in operation 320 to initiate the request to communicate with the destination resource, wherein the internal connection may include traffic that the client device communicates using Transmission Control Protocol (TCP), Internet Protocol (IP), Secure Socket Layer (SSL), User Datagram Protocol (UDP), Internet Control Message Protocol (ICMP), Hypertext Transfer Protocol (HTTP), File Transfer Protocol (FTP), or any other suitable communication protocol. In one implementation, in response to the client device establishing the internal connection to communicate with the destination resource, the traffic delivery module may then establish an external connection with the destination resource to establish an appropriate session between the client device and the destination resource. As such, an operation 330 may include attaching a connection tracer to the internal connection between the client device and the load balancer, wherein the connection tracer may attach a cookie, session identifier, header, or other suitable identifier to the internal connection. In addition, operation 330 may similarly attach a connection tracer to the external connection that the load balancer establishes with the destination resource, whereby the connection tracers may monitor the internal and external connections established with the load balancer to handle incoming and outgoing traffic associated with the request. Further, an operation 340 may include the load balancer subsequently receiving incoming traffic directed to the client device in response to the request from the client device. Thus, in one implementation, the load balancer may determine whether any incoming connections that return the traffic in response to the request originate from a resource remote from the data center in an operation 350, wherein an operation 360 may include similarly attaching connection tracers into the incoming connections returning the traffic to the load balancer in response to the request originating from a resource remote from the data center.

In one implementation, the method 300 may therefore generally include the traffic tracers collecting data describing any traffic passed through the load balancer in the internal and external connections established with the load balancer. In particular, as noted above, the connection tracers may insert cookies, session identifiers, headers, or other identifiers into the internal and external sessions established with the load balancer, wherein the connection tracers may then notify the traffic tracers in response to detecting any traffic passing through the load balancer in the internal and external connections. As such, in response to the traffic tracers receiving the notification that the internal and external connections are passing traffic through the load balancer, the traffic tracers may collect data describing the traffic. Furthermore, the traffic tracers may reference the configuration read from the indexing service to apply one or more heuristics, filters, and other rules to the data collected from the traffic that the internal and external connections pass through the load balancer. In particular, the configuration may define certain identity controls, policies, service level agreements, or other criteria that define relevant management data to collect from the traffic passing through the load balancer, whereby applying the heuristics, filters, and other rules to the collected data may normalize, organize, or otherwise control the nature of the collected data that passes through the load balancer. For example, the outgoing traffic originating from the client device may include communications directed to multiple destination resources, whereby having the traffic tracers and the connection tracers monitor the traffic passing through the load balancer and the internal and external connections with the load balancer in view of the applied heuristics, filters, and other rules may distinguish particular ones of the multiple destination resources that communicated any responses that may be received in operation 340.

In one implementation, the load balancer may further decode various messages within the incoming and traffic that include encrypted data. In particular, various communication protocols typically encrypt segments within connections that pass traffic through the load balancer to provide secure transit for certain types of data. As such, in response to the traffic tracers applying the heuristics, filters, and other rules to the data collected from the traffic, an operation 370 may include determining whether the collected data includes one or more encrypted messages. In one implementation, in response to determining that the collected data includes encrypted messages, the load balancer may then decode the encrypted messages in an operation 380 and then further apply the heuristics, filters, and other rules to the decoded messages in order to collect any relevant management data. Alternatively (or additionally), operation 370 may further include the traffic tracers initially applying the heuristics, filters, and other rules to determine whether to decode the encrypted messages in operation 380 (e.g., operation 380 may be bypassed for any encrypted messages that include personal data to protect user privacy, whereas encrypted messages directed to an application that interacts with corporate data may be decoded in operation 380 to manage governance, risk, and compliance).

In one implementation, in response to the traffic tracers applying the heuristics, filters, and other rules to the data collected from the traffic passing through the load balancer, an operation 390 may include providing the resulting data to the indexing service, wherein the indexing service may order the resulting data according to time, content, or other suitable criteria. In one implementation, operation 390 may include the indexing service employing any suitable technique to order the data collected with the traffic tracers and then storing the ordered data in one or more databases or other suitable repositories. In one implementation, operation 390 may then further include the indexing service analyzing the ordered data to obtain any relevant governance, risk, and compliance data associated with the incoming and outgoing traffic that passed through the load balancer. In particular, the indexing service may be configured with various requirements that define relevant governance, risk, and compliance parameters that may apply to the incoming and outgoing traffic that passed through the load balancer, whereby the indexing service may analyze the ordered data in accordance with the defined requirements to generate a report on the incoming and outgoing traffic traced with the connection tracers and the traffic tracers. In one implementation, the report generated in operation 390 may then be sent to a troubleshooting system, help desk system, or any other suitable system or application that may request or require the report. Thus, the method 300 may generally enable the workload management system to obtain any suitable management data relevant to managing incoming and outgoing traffic that passes through the load balancer.

Implementations of the invention may be made in hardware, firmware, software, or various combinations thereof. The invention may also be implemented as instructions stored on a machine-readable medium, which may be read and executed using one or more processing devices. In one implementation, the machine-readable medium may include various mechanisms for storing and/or transmitting information in a form that can be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. While firmware, software, routines, or instructions may be described in the above disclosure in terms of specific exemplary aspects and implementations performing certain actions, it will be apparent that such descriptions are merely for the sake of convenience and that such actions in fact result from computing devices, processing devices, processors, controllers, or other devices or machines executing the firmware, software, routines, or instructions.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What is claimed is:

1. A system for providing load balancer visibility in an intelligent workload management system, comprising:
a client device located in an information technology data center; and
a workload management system that manages the information technology data center, wherein the workload management system includes a load balancer configured to:
establish an external connection with a destination resource in response to the client device establishing an internal connection with the load balancer, wherein the internal connection includes a request to communicate with the destination resource;
attach one or more connection tracers to the internal connection established between the client device and the load balancer and the external connection established between the load balancer and the destination resource;
monitor the internal connection with the client device and the external connection with the destination resource using the one or more connection tracers, wherein the connection tracers monitor the internal connection and the external connection to detect incoming traffic and outgoing traffic that the internal connection and the external connection pass through the load balancer;
collect data from the incoming traffic and the outgoing traffic that the internal connection and the external connection pass through the load balancer with one or more traffic tracers, wherein the one or more traffic tracers collect the data from the incoming traffic and the outgoing traffic in response to the connection tracers detecting the incoming traffic and the outgoing traffic; and
generate a report describing the data that the one or more traffic tracers collect from the incoming traffic and the outgoing traffic passed through the load balancer, wherein the workload management system manages the information technology data center using the report describing the data collected from the incoming traffic and the outgoing traffic passed through the load balancer.

2. The system of claim 1, wherein the load balancer further attaches the one or more connection tracers to a connection that the destination resource establishes with the load balancer, wherein the destination resource establishes the connection with the load balancer to pass the incoming traffic through the load balancer in response to the request that passes the outgoing traffic from the client device to the destination resource.

3. The system of claim 2, wherein the load balancer is further configured to distinguish one of multiple machines associated with the destination resource that passed the incoming traffic through the load balancer in response to the request from the client device.

4. The system of claim 1, wherein the connection tracers detect the incoming traffic and the outgoing traffic passing through the load balancer in response to the incoming traffic and the outgoing traffic including a cookie, session identifier, or header associated with the internal connection and the external connection.

5. The system of claim 1, wherein the connection tracers notify the traffic tracers to collect the data from the incoming traffic and the outgoing traffic in response to the incoming traffic and the outgoing traffic identifying a virtual network address that the load balancer assigned to the client device.

6. The system of claim 1, wherein the load balancer is further configured to decode one or more encrypted messages in the incoming traffic or the outgoing traffic to collect the data from the one or more encrypted messages.

7. The system of claim 1, wherein the workload management system further includes an indexing service that orders the data collected from the incoming traffic and the outgoing traffic according to time or content associated with the collected data.

8. The system of claim 1, wherein the workload management system further includes one or more additional load balancers configured to monitor incoming traffic and outgoing traffic that passes through the multiple load balancers and generate reports describing data collected from the incoming traffic and the outgoing traffic passed through the multiple load balancers.

9. The system of claim 1, wherein the workload management system further includes an indexing service having one or more configurations that the load balancer applies to configure the one or more connection tracers and the one or more traffic tracers.

10. The system of claim 9, wherein the load balancer is further configured to:
read the one or more configurations from the indexing service that define one or more requirements for the data to collect from the incoming traffic and the outgoing traffic passed through the load balancer;
filter the data that the traffic tracers collect from the incoming traffic and the outgoing traffic according to the one or more requirements defined in the configurations read from the indexing service; and
provide the generated report to an application that submitted the one or more requirements to the indexing service, wherein the application uses the report to manage the information technology data center.

11. A method for providing load balancer visibility in an intelligent workload management system, comprising:
establishing an external connection with a destination resource in response to a client device located in an information technology data center establishing an internal connection with a load balancer, wherein the internal connection includes a request to communicate with the destination resource;
attaching one or more connection tracers to the internal connection established between the client device and the load balancer and the external connection established between the load balancer and the destination resource;
monitoring the internal connection with the client device and the external connection with the destination resource using the one or more connection tracers, wherein the connection tracers monitor the internal connection and the external connection to detect incoming traffic and outgoing traffic that the internal connection and the external connection pass through the load balancer;
collecting data from the incoming traffic and the outgoing traffic that the internal connection and the external connection pass through the load balancer with one or more traffic tracers, wherein the one or more traffic tracers collect the data from the incoming traffic and the outgoing traffic in response to the connection tracers detecting the incoming traffic and the outgoing traffic; and
generating a report describing the data that the one or more traffic tracers collect from the incoming traffic and the outgoing traffic passed through the load balancer, wherein a workload management system manages the information technology data center using the report describing the data collected from the incoming traffic and the outgoing traffic passed through the load balancer.

12. The method of claim 11, wherein the load balancer further attaches the one or more connection tracers to a connection that the destination resource establishes with the load balancer, wherein the destination resource establishes the connection with the load balancer to pass the incoming traffic through the load balancer in response to the request that passes the outgoing traffic from the client device to the destination resource.

13. The method of claim 12, further comprising distinguishing one of multiple machines associated with the destination resource that passed the incoming traffic through the load balancer in response to the request from the client device.

14. The method of claim 11, wherein the connection tracers detect the incoming traffic and the outgoing traffic passing through the load balancer in response to the incoming traffic and the outgoing traffic including a cookie, session identifier, or header associated with the internal connection and the external connection.

15. The method of claim 11, further comprising notifying the traffic tracers to collect the data from the incoming traffic and the outgoing traffic in response to the connection tracers detecting that the incoming traffic and the outgoing traffic identifies a virtual network address that the load balancer assigned to the client device.

16. The method of claim 11, wherein the load balancer decodes one or more encrypted messages in the incoming traffic or the outgoing traffic to collect the data from the one or more encrypted messages.

17. The method of claim 11, further comprising ordering the data collected from the incoming traffic and the outgoing traffic with an indexing service, wherein the indexing service orders the collected data according to time or content associated with the collected data.

18. The method of claim 11, wherein the workload management system includes one or more additional load balancers that monitor incoming traffic and outgoing traffic that passes through the multiple load balancers and generate reports describing data collected from the incoming traffic and the outgoing traffic passed through the multiple load balancers.

19. The method of claim 11, further comprising reading one or more configurations from an indexing service, wherein the load balancer applies the one or more configurations read from the indexing service to configure the one or more connection tracers and the one or more traffic tracers.

20. The method of claim 19, further comprising:
defining one or more requirements for the data to collect from the incoming traffic and the outgoing traffic passed through the load balancer, wherein the load balancer defines the one or more requirements from the one or more configurations read from the indexing service;
filtering the data that the traffic tracers collect from the incoming traffic and the outgoing traffic according to the one or more requirements defined in the configurations read from the indexing service; and
providing the generated report to an application that submitted the one or more requirements to the indexing service, wherein the application uses the report to manage the information technology data center.
